(19) United States
(12) Patent Application Publication
(10) Pub. No.: US 2012/0031288 A1
(43) Pub. Date: Feb. 9, 2012

(54) PRINTING UNIT OF A PRINTING PRESS HAVING AT LEAST ONE PRINTING UNIT

(76) Inventor: Andrea Kümmet, Zell am Main (DE)

(21) Appl. No.: 13/138,590

(22) PCT Filed: Mar. 10, 2010
(86) PCT No.: PCT/EP2010/053009

§ 371 Date: Sep. 8, 2011

(30) Foreign Application Priority Data
Mar. 11, 2009 (DE) 102009001475.6

(51) Int. Cl. B41F 5/00

(52) U.S. Cl. 101/216

(57) ABSTRACT

A press unit of a printing press has at least one printing unit which includes at least one plate cylinder and one transfer cylinder which interacts with the plate cylinder. An inking unit having a plurality of ink distribution cylinders is provided. The forme cylinder, the transfer cylinder, and all of the distribution cylinders of the inking unit are driven for rotation by the same single drive motor. The distribution cylinders of the inking unit are driven by the single drive motor by an arrangement of gear which includes a plurality of gearwheels. The distribution cylinders each have at least one spur gear and are driven directly and jointly by the engagement of the respective spur gear for each distribution cylinder with a central gearwheel that is rotatable about an axis of rotation. All of the distribution cylinders are driven directly and jointly by the central gearwheel.

### CROSS-REFERENCE TO RELATED APPLICATIONS

This application is the U.S. national phase, under 35 U.S.C. 371, of PCT/EP2010/053009, filed Mar. 10, 2010; published as WO2010/103027 A1 on Sep. 16, 2010; and claiming priority to DE 10 2009 001 475.6, filed Mar. 11, 2009, the disclosures of which are expressly incorporated herein by reference.

### FIELD OF THE INVENTION

The invention relates to a printing unit of a printing press having at least one printing couple. The printing unit has at least one forme cylinder and one transfer cylinder that interacts with the at least one forme cylinder. The printing unit also has an inking unit with a plurality of distribution cylinders. The forme cylinder and/or the transfer cylinder and all of the distribution cylinders of the printing couple are rotationally driven by the same drive motor. The distribution cylinders are driven by the drive motor by a transmission having a plurality of gear wheels. Each of the distribution cylinders has a spur gear. The plurality of distribution cylinders of the printing couple are driven, directly and jointly, by an engagement of each respective spur gear with a central gear wheel that is rotatable about a rotational axis. In an operating position, in which the central gear wheel is coupled into the path of power from the transmission, that central gear wheel is in direct toothed engagement with a gear wheel mounted on the rotational axis of the forme cylinder.

### BACKGROUND OF THE INVENTION

An inking unit of a printing couple of a sheet-fed printing press is known from EP 1 930 161 A2. A plurality of oscillating ink rollers are driven directly and jointly by a central drive wheel. However, an additional oscillating ink roller is not driven directly by the central drive wheel.

A printing unit for a printing press having at least one printing couple is known from DE 195 20 841 A1. The printing couple comprises at least one forme cylinder and one transfer cylinder that interacts with this forme cylinder, and an inking unit having a plurality of distribution cylinders. The forme cylinder and/or the transfer cylinder and all the distribution cylinders of this printing couple are rotationally driven by the same drive motor. The distribution cylinders are driven by the drive motor by a transmission comprising a plurality of gear wheels. Each of the distribution cylinders has a spur gear. The plurality of distribution cylinders of this printing couple are driven directly and jointly by an engagement of each spur gear with a central gear wheel that is rotatable about a rotational axis.

A printing unit of an offset rotary printing press comprising two printing couples is known from DE 197 53 931 A1, wherein each of these printing couples has one forme cylinder and one transfer cylinder that interacts with said forme cylinder, wherein the transfer cylinders of these printing couples are engaged against one another, wherein each of the two printing couples has an inking unit with three distribution cylinders, wherein each of the distribution cylinders has a spur gear on its journal, wherein each of the respective spur gears of the distribution cylinders in the same inking unit is in direct toothed engagement with the same central gearwheel, wherein during print operation, each respective central gearwheel is in drive connection, via at least one intermediate gear, with a motor that drives at least one of the forme cylinders, wherein the relevant intermediate gear can be disengaged from the drive connection with the forme cylinder of the respective printing couple by an axial displacement, wherein the spur gears of the distribution cylinders of the same inking unit remain in engagement with their respective central gearwheel even after the intermediate gear has been disengaged from the drive connection to the respective forme cylinder.

From WO 02/076744 A1, a drive for a printing couple comprising a first cylinder embodied as a forme cylinder is known, wherein a second cylinder which interacts with the forme cylinder and an inking unit assigned to the forme cylinder are provided, wherein the drive of the two cylinders originates from the forme cylinder, which drives the second cylinder via a drive connection, wherein the inking unit is driven by the second cylinder via a drive connection, wherein the forme cylinder can preferably be driven mechanically independently of the drive of another printing couple by a drive motor, wherein the inking unit assigned to the forme cylinder is driven by means of the same drive motor, and wherein the drive connection between the second cylinder and the forme cylinder is embodied as a gear train.

From DE 10 2006 035 713 A1, an inking unit drive in a machine for processing print substrates, comprising an inking unit having a plurality of oscillating ink rollers, is known, wherein input applied from a printing press cylinder to a central inking unit drive wheel can be fed in, and can be output from this onto the rotationally and axially oscillating, drivable ink distribution rollers, wherein the inking unit drive wheel is disposed freely rotating on a stationarily mounted gear shaft, wherein a clutch is disposed on the gear shaft, fixed in position adjacent to the inking unit drive wheel, wherein when the clutch is in the engaged state, it is coupled with the inking unit drive wheel to allow the transfer of torque, and in the disengaged state it is uncoupled from the inking unit drive wheel, and wherein fixed in position on the gear shaft is an inking unit follower gear, with which output can be realized on the ink distribution rollers when the clutch is engaged.

From DE 10 2006 036 511 A1, a drive for an offset printing press is known, wherein in a gear train of this drive, a displaceable gear wheel is provided, wherein with this displaceable gear wheel, a flow of power from a gear wheel disposed non-rotatably on a shaft of a plate cylinder to a rotatable roller of an inking unit can be produced.

From CH 439 338 A, an inking unit for printing couples of rotary printing presses, which couples are operated in two directions of rotation, are known, wherein intermediate gears that can be disengaged are disposed in the inking unit drive.

From DE 24 58 772 A1, a rotary printing press having an inking unit is known, wherein during operation, the inking unit is driven by the press drive, and during washing, said unit is driven by an auxiliary motor, wherein the two drives can be separated from one another by a coupling on the plate cylinder shaft, wherein the drive wheel of the plate cylinder consists of two spur gears, which can be connected to one another via an electromagnetic tooth clutch, wherein the gear wheel that is engaged with the blanket cylinder drive wheel is disposed movably on the plate cylinder shaft, and the gear wheel that drives the inking unit gears is disposed non-rotatably on the plate cylinder shaft.

### SUMMARY OF THE INVENTION

The problem addressed by the invention is that of devising a printing unit for a printing press that has at least one printing couple, and has a drive train that can be produced cost-effectively, wherein this drive train can be disposed in an installation space of low overall height.

The problem is solved according to the invention by the driving of all of the distribution cylinders of the printing couple directly and jointly by the central gear wheel. That central gear wheel is configured as an individual gear that has only a single ring gear. All of the gear wheels of the entire transmission are straight cut.

The advantages to be achieved with the invention consist particularly in that the printing couple of the printing unit is extremely compact in structure and has a drive train that can be cost-effectively produced. The transmission of the drive train requires only a small number of gear wheels, because the gear train is embodied as very short. Because the drive motor transfers its torque via only a small number of gear wheels, this transmission relatively highly efficient. Because the drive train originating from the drive motor ends at the spur gears of the distribution cylinders, no additional space-consuming gear wheels are provided in this drive train. The transmission of the drive train can therefore be implemented in an installation space having an overall height that occupies less than 80%, preferably less than 60%, of the overall height of the entire printing couple. The space that is gained as a result of the compactly structured transmission of the printing couple in and/or on the frame of the printing unit can advantageously be used for positioning other machine components that are required in the printing unit, i.e., particularly units and/or control elements and/or cable fittings, resulting in a novel concept for the structure and the configuration of this printing unit.

### BRIEF DESCRIPTION OF THE DRAWINGS

One embodiment example of the invention is illustrated in the set of drawings, and will be specified in greater detail in what follows.

The drawings show:

FIG. 1 a roller configuration for a printing unit comprising two printing couples;

FIG. 2 a schematic illustration of a transmission for one of the printing couples illustrated in FIG. 1;

FIG. 3 a perspective illustration of a section of the transmission of FIG. 2.

### DESCRIPTION OF THE PREFERRED EMBODIMENT

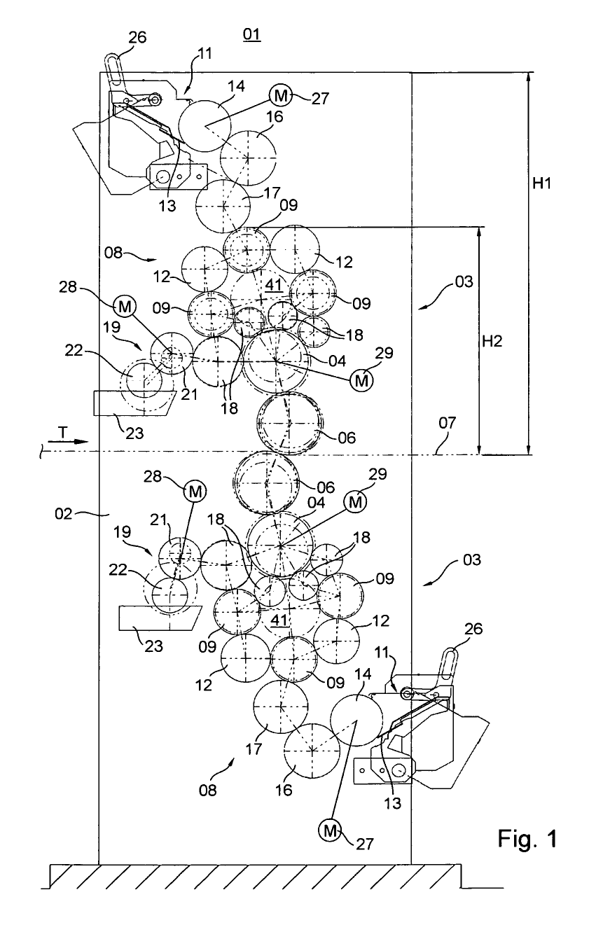

FIG. 1 shows, by way of example, a roller configuration of a printing unit 01 for an offset rotary printing press that is preferably used in commercial printing, comprising a plurality of printing couples 03, particularly two, arranged one above the other vertically in the same frame 02, for example, wherein each of these printing couples 03 has a forme cylinder 04 and a transfer cylinder 06 that interacts with said forme cylinder 04, wherein the transfer cylinders 06 of these printing couples 03 are engaged against one another at least when this printing unit 01 is in print operation, wherein a print substrate 07 indicated in FIG. 1 by a dashed line, for example, a web of print substrate 07, particularly a paper web 07, is guided essentially horizontally through this printing unit 01 in a direction of transport T between the transfer cylinders 06 engaged against one another. The forme cylinder 04 is covered on its outer surface by at least one printing forme, which preferably spans its entire circumference. At least one printing blanket, for example, a metal printing blanket, is secured on the outer surface of the transfer cylinder 06.

Each of the two printing couples 03, which are essentially structurally identical and configured as mirror images from the path of the print substrate web 07, has an inking unit 08 with a plurality of distribution cylinders 09, particularly three, wherein on one of these distribution cylinders 09, ink that is drawn from an ink reservoir 11 assigned to the respective inking unit 08 to form an ink flow is divided into a main ink flow and a secondary ink flow, wherein the main ink flow and the secondary ink flow are fed, each via a single ink transfer roller 12, to another of the two additional distribution cylinders 09, for example, belonging to the respective inking unit 08. In the preferred embodiment, the ink flow drawn from the ink reservoir 11 is fed to the center of the three distribution cylinders 09, which are preferably arranged in a circular arch, particularly in a semicircle, wherein the respective centers of the distribution cylinders 09 in this arch are arranged offset from one another, for example, by approximately or at least 90°.

The ink reservoir 11 is embodied, for example, as an ink fountain 11, having a plurality of ink keys, for example, more than twenty, arranged side by side, transversely to the direction of transport T of the print substrate 07, wherein in each ink key, a controllable ink metering element 13, particularly an ink blade 13, is provided, which can be adjusted for metering the volume of ink to be delivered from the ink reservoir 11, wherein ink held in the ink reservoir 11 is taken up, in a volume that is adjusted in the relevant ink key by the respective ink metering element 13, by a rotatable ink fountain roller 14, and is delivered, for example, to an ink film roller 16 disposed adjacent to the ink fountain roller 14, for example. The ink film roller 16 transfers ink that is taken up by the ink fountain roller 14 over only a single ink transfer roller 17 to the specific distribution cylinder 09 that divides the ink flow received from the ink reservoir 11 into the aforementioned main ink flow and secondary ink flow. The ink fountain 11 can be pivoted against or pivoted away from the respective ink fountain roller 14, which is mounted rotatably but fixed in position in the frame 02, by actuating at least one lever 26, for example, with both of these operating positions of the respective ink fountain 11 being indicated in FIG. 1.

Both the distribution cylinder 09 disposed in the main ink flow and the distribution cylinder 09 disposed in the secondary ink flow pass ink received from their respective ink transfer roller 12 on to the respective forme cylinder 04 via two ink forme rollers 18 each, wherein either in the main ink flow or in the secondary ink flow, one of the two ink forme rollers 18 can also be used as a dampening forme roller, if the relevant printing couple 03 is equipped with a dampening unit 19, for example, a film dampening unit 19, more particularly, a three-cylinder film dampening unit 19.

The three distribution cylinders 09 of the inking unit 08 preferably have an outer surface made of a plastic, particularly made of Rilsan. The outer surfaces both of the ink transfer rollers 12 disposed between the distribution cylinders 09 and of all the ink forme rollers 18 are coated with rubber, i.e., with an elastomeric material. The ink film roller 16 also preferably has an outer surface made of Rilsan, wherein this outer surface is embodied, for example, as having a rhombic structure. The ink film roller 16 is mounted at both ends in the frame 02, preferably so as to pivot on levers. The ink fountain roller 14 has an outer surface made of a ceramic, for example. Between the ink fountain roller 14 and the ink film roller 16, a gap, the width of which is variably adjustable, is formed, with a preferred width of this gap being 0.08 mm. If a three-cylinder dampening unit 19 is provided, the center roller is embodied, for example, as a preferably non-oscillating dampness distributing roller 21, with an outer surface made of chromium, which transfers a dampening agent picked up by a dampening fountain roller 22 from a dampening agent reservoir 23 to the ink forme roller 18 used as a dampening forme roller.

In the preferred embodiment of the inking unit 08, all of the ink forme rollers 18 and ink transfer rollers 12; 17 and the ink film roller 16 are driven via friction. The ink fountain roller 14 is independently rotationally driven by a preferably electric drive motor 27. The dampness distributing roller 21 of the dampening unit 19 is also independently driven by a preferably electric drive motor 28, wherein this drive motor 28 also drives the dampening fountain roller 22 at a lower speed than the dampness distributing roller 21, preferably via a gear train.

Each of the two printing couples 03 disposed in the same printing unit 01 has its own preferably electric drive motor 29 for its respective forme cylinder 04, which motor is independent of the other printing couple 03, wherein the speed and angular position of this drive motor 29 are preferably regulated by an electronic drive controller, which is connected at least for data transmission purposes to a virtual guide axis. The two printing couples 03 are therefore driven individually and separately from one another.

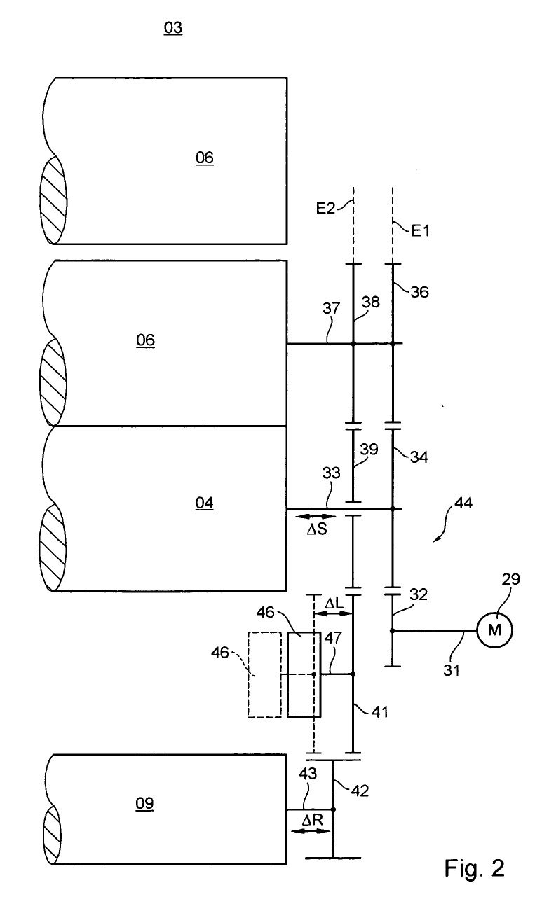

For one of the printing couples 03, the assigned drive train, originating from the relevant drive motor 29, is illustrated by way of example in FIG. 2. A level of torque provided by the respective drive motor 29 is preferably transferred directly and immediately, for example, without a clutch, via a pinion gear 32, which is non-rotatably connected to the rotational axis 31 of this drive motor 29, to a gear wheel 34, which is non-rotatably connected to the rotational axis 33 of the forme cylinder 04, whereby said forme cylinder 04 is rotationally driven or at least can be rotationally driven, particularly according to the specifications of the guide axis. To rotationally drive the transfer cylinder 06 that interacts with this forme cylinder 04, a gear wheel 36, which is non-rotatably connected to the rotational axis 37 of this transfer cylinder 06, meshes with the gear wheel 34, which is non-rotatably connected to the rotational axis 33 of the forme cylinder 04. A transfer cylinder 06 of the other printing couple 03 of this printing unit 01, which is engaged or at least can be engaged against the transfer cylinder 06 of this printing couple 03, and which acts as the impression cylinder for the printing couple shown in FIG. 2 in the illustration of the drive thereof, is not incorporated into the drive train of the former printing couple 03, and is instead completely separate therefrom with respect to its drive. Pinion gear 32, which is non-rotatably connected to the rotational axis 31 of the drive motor 29, gear wheel 34, which is non-rotatably connected to the rotational axis 33 of the forme cylinder 04, and gear wheel 36, which is non-rotatably connected to the rotational axis 37 of the assigned transfer cylinder 06, are disposed essentially within the same first, preferably vertical plane, which is orthogonal to these rotational axes 31; 33; 37, which are parallel to and spaced from one another. Alternatively, it is also possible to drive the transfer cylinder 06 directly and immediately, and then to incorporate the relevant forme cylinder 04 into the flow of power originating from the drive motor 29.

A second gear wheel 38 is preferably non-rotatably disposed on the rotational axis 37 of the transfer cylinder 06 of the first printing couple 03, illustrated by way of example in FIG. 2, wherein this second gear wheel 38 is in toothed engagement with a gear wheel 39 that is preferably mounted so as to rotate freely at least on the rotational axis 33 of the forme cylinder 04. Alternatively, these two gear wheels 36; 38, disposed on the rotational axis 37 of the same transfer cylinder 06, can also be embodied as a single component comprising a double-width gear wheel, for example, or as a so-called double gear.

The gear wheel 39, which is mounted so as to rotate freely at least on the rotational axis 33 of the forme cylinder 04, and preferably also so as to slide axially on the rotational axis 33 of the forme cylinder 04, can be brought immediately and directly into toothed engagement with a gear wheel 41, which is non-rotatably connected to a rotational axis 47 and is centrally disposed in the inking unit 08, wherein this gear wheel 41 disposed centrally in the inking unit 08 is in preferably permanent toothed engagement with at least one spur gear 42, i.e., with a cylindrical gear wheel 42 that has teeth along its periphery, which spur gear 42 is non-rotatably connected to the rotational axis 43 of one of the three distribution cylinders 09, for example, of the relevant inking unit 08. The second gear wheel 38, which is non-rotatably disposed on the rotational axis 37 of the transfer cylinder 06, gear wheel 39, which is mounted so as to rotate freely at least on the rotational axis 33 of the forme cylinder 04, and gear wheel 41, which is disposed centrally in the inking unit 08, are disposed essentially within the same second plane E2, which is likewise preferably vertical, and is orthogonal to the stated rotational axes 37; 33; 47, which are parallel to and spaced from one another, wherein this second plane E2 is different from the above-described first plane E1. The two planes E1; E2 extend parallel to one another.

In the preferred embodiment, the spur gears 42 of all three distribution cylinders 09 of the relevant inking unit 08 mesh immediately and directly with gear wheel 41, which is disposed centrally in the inking unit 08, wherein all of these spur gears 42 are in preferably permanent toothed engagement with the gear wheel 41, which is disposed centrally in the inking unit 08. The spur gears 42 of the distribution cylinders 09 are therefore arranged in the manner of planetary gears around the gear wheel 41, which is disposed centrally in the inking unit 08. Gear wheel 41, disposed centrally in the inking unit 08, is embodied as a single gear, i.e., two or more gear wheels are not arranged on the rotational axis 47 thereof in the different parallel planes E1; E2 and orthogonal to the rotational axis 47.

The drive train originating from the drive motor 29 of this printing couple 03 ends at the spur gears 42 of the distribution cylinders 09, and therefore, no additional rotational bodies, i.e., rollers and/or cylinders of the relevant printing couple 03, are incorporated with respect to drive into this drive train. The drive train is preferably embodied as a transmission 44, more particularly, as a gear train 44, as described in reference to FIG. 2, in which all interacting gear wheels 32; 34; 36; 38; 39; 41; 42 are straight cut, i.e., the gearing thereof is embodied as axially parallel. Because no helical-cut gear wheels are used in the gear train of the transmission in addition to the straight-cut gear wheels 32; 34; 36; 38; 39; 41; 42 or in place of these, this transmission 44 has no tooth advance, and therefore, certain gear wheels 39; 41; 42 can be axially displaced in a simple manner, wherein the gear wheel 39; 41; 42 to be displaced can remain in toothed engagement with at least one other gear wheel 38; 39; 41; 42. The rotational axes 31; 33; 37; 43; 47 of all the gear wheels 32; 34; 36; 38; 39; 41; 42 interacting in this transmission 44 are arranged parallel with one another. Both the use of spur gears and the straight cut thereof contribute to the fact that this transmission 44 can be produced cost-effectively. The gear train of the transmission 44 is indicated in FIG. 1 by dotted-dashed circles. The forme cylinder 04 is preferably mounted so as to be axially displaceable along an adjustment path ΔS for adjusting a lateral register in the frame 02, wherein this adjustment path ΔS ranges between 1 mm and 5 mm, for example. It can be provided that the gear wheel 39, which is mounted so as to rotate freely on the rotational axis 33 of the forme cylinder 04, moves with it laterally along this axial adjustment path ΔS, and is therefore disposed fixed in position on the rotational axis 33 of the forme cylinder 04. In order to keep the transfer cylinder 06 of the printing couple 03 in a specific angular position relative to the forme cylinder 04 that interacts with it, the transfer cylinder 06 is incorporated into the drive train that is formed by the transmission 44, and into the resulting flow of force. In this printing couple 03, a circumferential register of the forme cylinder 04 can be adjusted by means of the drive motor 29 that acts on this forme cylinder 04, through the adjustment of a specific angular position of this forme cylinder 04, carried out, for example, from a control panel belonging to the printing unit 01. Therefore, helical teeth on at least one pair of interacting gear wheels 32; 34; 36; 38; 39; 41; 42 in the gear train of the transmission are not required for the purpose of adjusting the circumferential register. Instead, the preferably entirely straight teeth of the gear wheels 32; 34; 36; 38; 39; 41; 42 of this transmission 44 enable an adjustment of the lateral register of the forme cylinder 04 that can be carried out easily, because gear wheels 32; 34; 36; 38; 39; 41; 42 of the transmission 44 that interact in direct contact can each be displaced axially and therefore axially parallel to one another, without affecting the circumferential register of the forme cylinder 04.

Gear wheel 41, which is disposed centrally in the inking unit 08, is preferably embodied as an individual coupling wheel 41, which can be displaced linearly along its rotational axis 47 by means of a controllable, for example, pneumatic positioning element 46, for example, a pneumatic cylinder 46, along an adjustment path ΔL, thereby allowing this coupling wheel 41 to be coupled into or uncoupled from a flow of power from the transmission 44. The positioning element 46 can be controlled, for example, from the control panel belonging to the printing unit 01. Independently of the displacement of the central gear wheel 41, i.e., independently of the operating position thereof, said wheel remains permanently in toothed engagement with the respective spur gear 42 of each distribution cylinder 09. FIG. 2 shows the two operating positions of the central gear wheel 41, wherein the operating position of the central gear wheel 41 after it has been uncoupled from the flow of power from the transmission 44 is indicated by dashed lines. The embodiment of the gear wheel 41 disposed centrally in the inking unit 08 as an individual wheel having only a single ring gear is naturally more advantageous than the embodiment thereof as a double wheel with two ring gears disposed offset from and parallel to one another on the same rotational axis 47.

Because only a small number of gear wheels 32; 34; 36; 38; 39; 41; 42 are integrated into the transmission 44, and because in the operating state in which the central gear wheel 41 is coupled into the flow of power from the transmission 44, said gear wheel is in direct toothed engagement with a gear wheel 39 that is mounted on the rotational axis 33 of the forme cylinder 04, this transmission 44 has an installation space having an overall height H2 of less than 80%, particularly less than 60%, of the overall height H1 of the printing couple 03, wherein the overall height H1 of the printing couple 03 in the printing unit 01 illustrated by way of example in FIG. 1 is approximately half the height of the frame thereof. This low installation space for the transmission 44, in turn, contributes to the fact that a very compact printing unit 01 can be realized, because space is gained in and/or on the frame 02 of the printing unit 01, which can be advantageously used for arranging other units and/or control elements and/or cable fittings, particularly electric and/or pneumatic lines, which are required in this printing unit 01. For instance, particularly the drive motor 27 for the ink fountain roller 14 can be located outside of the installation space of the transmission 44. In contrast, the drive motor 28 for the dampening unit 19, i.e., particularly a pinion gear connected to a rotational axis of said drive motor 28 and/or a jointed shaft connected to the rotational axis of said drive motor 28, preferably projects into the installation space of the transmission 44.

In print operation and therefore in the operating setting in which the gear wheel 41 that is disposed centrally in the inking unit 08 is engaged with the drive train, the circumferential speed of the distribution cylinders 09 is faster or slower than the circumferential speed of the transfer cylinder 06, and therefore, slippage is formed between the respective distribution cylinder 09 and a friction-driven roller 12; 17; 18 that is adjacent to the relevant distribution cylinder 09, wherein this slippage is preferably less than 0.5%. The faster or slower speed than the distribution cylinders 09 is adjusted via a gear ratio resulting from the ratio of the number of teeth on the spur gear 42 of the relevant distribution cylinder 09 to the number of teeth on the second gear wheel 38, disposed non-rotatably in the same plane E2 on the rotational axis 37 of the transfer cylinder 06.

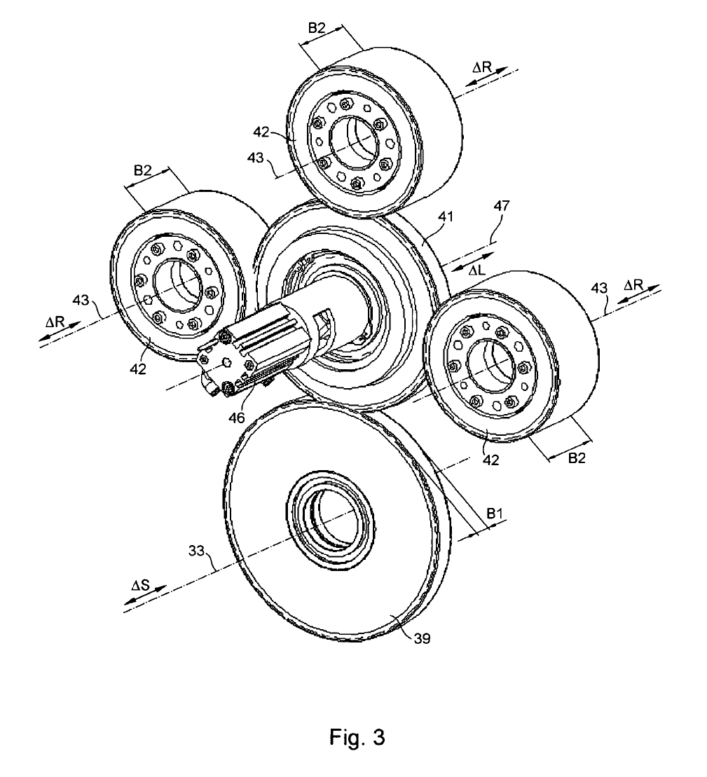

FIG. 3 shows a perspective illustration of a section of the transmission 44, wherein the central gear wheel 41 and the three spur gears 42 of the distribution cylinders 09 grouped around this central gear wheel 41, along with the gear wheel 39 that is mounted on the rotational axis 33 of the forme cylinder 04 and can be brought into toothed engagement with the central gear wheel 41, are shown in simplified form. In the interest of clarity, the distribution cylinders 09 and the forme cylinder 04 itself, along with the respective axial journals thereof that support the assigned gear wheels 39; 42, are not shown in FIG. 3, and instead, only the respective rotational axes 33; 43 thereof are indicated by dotted-dashed lines.

Gear wheel 39, which can be placed in toothed engagement with the central gear wheel 41 and is mounted on the rotational axis 33 of the forme cylinder 04, has an axial width B1, particularly an edge width B1, which is less than one-half an axial width B2, for example, more particularly, edge width B2 of the spur gears 42 of the distribution cylinders 09. The edge width B2 of the spur gears 42 of the distribution cylinders 09 ranges, for example, from 60 mm to 100 mm, whereas the edge width B1 of gear wheel 39 mounted on the rotational axis 33 of the forme cylinder 04 ranges, for example, from 10 mm to 50 mm. The rotational axes 33; 43; 47 of the gear wheels 39; 42 that interact with the central gear wheel 41 are arranged parallel with one another.

FIG. 3 also shows positioning element 46, which can be used to couple the central gear wheel 41 with the flow of power from the transmission 44, i.e., placing it in toothed engagement with the gear wheel 39 that is mounted on the rotational axis 33 of the forme cylinder 04, and/or to uncouple it from this power flow. By a particularly remotely triggered actuation of the positioning element 46, the central gear wheel 41, shown in FIG. 3 in its engaged operating position, is displaced linearly along its rotational axis 47 along the adjustment path ΔL, thereby bringing this central gear wheel 41 out of engagement with the gear wheel 39 mounted on the rotational axis 33 of the forme cylinder 04, wherein the central gear wheel 41 remains in toothed engagement with the spur gears 42 of the distribution cylinders 09 that are grouped around the central gear wheel 41, due to their respectively greater, i.e., at least twice as large, edge width B2. The adjustment path ΔL ranges from 15 mm to 40 mm, for example. The positioning element 46 is embodied, for example, as a dual-action operating cylinder, or, if it is embodied as a single-action operating cylinder, the engagement process executed by the positioning element 46 can run counter to the force of a spring element, so that the central gear wheel 41 remains in the operating state brought about by the positioning element 46 only as long as the actuation of this positioning element 46 persists. Once the actuation of the positioning element 46 ceases, the force of the spring element pushes the central gear wheel 41 back to its operating state prior to actuation of the positioning element 46. Alternatively, the positioning element 46 can actively displace the central gear wheel 41 alternately into the two operating states thereof. In the operating state in which the central gear wheel 41 is brought out of engagement with gear wheel 39, which is mounted on the rotational axis 33 of the forme cylinder 04, the inking unit 08 is placed in idle status, and therefore does not function.

As is also clear from FIG. 3, the three distribution cylinders 09 and the gear wheel 39 mounted on the rotational axis 33 of the forme cylinder 04 are arranged around the central gear wheel 41, each at an offset ranging from 60° to 120°, preferably ranging from 70° to 110°, particularly about 90°. The spur gears 42 of the distribution cylinders 09 each have a diameter ranging from 120 mm to 150 mm, for example. The diameter of the central gear wheel 41 ranges, for example, from 120 mm to 400 mm, preferably ranging from 150 mm to 300 mm, particularly ranging from 150 mm to 200 mm. In print operation, the three distribution cylinders 09 each execute, for example, an oscillating movement, wherein these three distribution cylinders 09 oscillate opposite one another, with their movements relative to one another being offset preferably by one-third, for example, of a total stroke AR that can be executed by each of the three distribution cylinders 09, or of a revolution of a crank wheel (not shown) that drives the oscillating movement of the distribution cylinders 09. The total stroke ΔR that can be executed by each of the three distribution cylinders 09 ranges, for example, from 10 mm to 50 mm.

While a preferred embodiment of a printing unit of a printing press having at least one printing couple, in accordance with the present invention, has been set forth fully and completely hereinabove, it will be apparent to one of skill in the art that various changes could be made in, for example, the sizes of the cylinders, the number of distribution cylinders, the drive motor and the like, without departing from the true spirit and scope of the present invention which is accordingly to be limited only by the appended claims.

What is claimed is:

1-25. (canceled)

26. A printing unit (01) of a printing press having at least one printing couple (03), wherein the printing couple (03) comprises at least one forme cylinder (04) and one transfer cylinder (06) that interacts with this forme cylinder (04) and an inking unit (08) having a plurality of distribution cylinders (09), wherein the forme cylinder (04) and/or the transfer cylinder (06) and all the distribution cylinders (09) of this printing couple (03) are rotationally driven by the same drive motor (29), wherein the distribution cylinders (09) are driven by the drive motor (29) by means of a transmission (44) having a plurality of gear wheels (32; 34; 36; 38; 39; 41; 42), wherein each of the distribution cylinders (09) has a spur gear (42), wherein the plurality of distribution cylinders (09) of this printing couple (03) are driven directly and jointly by an engagement of each respective spur gear (42) with a central gear wheel (41) that is rotatable about a rotational axis (47), wherein in the operating position in which the central gear wheel (41) is coupled into a flow of power from the transmission, said gear wheel is in direct toothed engagement with a gear wheel (39) mounted on a rotational axis (33) of the forme cylinder (04), characterized in that all the distribution cylinders (09) of this printing couple (03) are driven directly and jointly by the central gear wheel (41), wherein the central gear wheel (41) is embodied as an individual gear having only a single ring gear, wherein all the gear wheels (32; 34; 36; 38; 39; 41; 42) of the entire transmission (44) are straight cut.

27. The printing unit (01) according to claim 26, characterized in that the central gear wheel (41), which drives a plurality of distribution cylinders (09) of this printing couple (03) directly and jointly, can be coupled into the power flow from the transmission (44) and/or uncoupled from this flow by means of a controllable positioning element (46).

28. The printing unit (01) according to claim 27, characterized in that the central gear wheel (41) is embodied as a coupling wheel, which can be brought into two different operating positions by the positioning element (46).

29. The printing unit (01) according to claim 28, characterized in that the central gear wheel (41) can be linearly displaced alternately between its two operating positions along its rotational axis (47) on an adjustment path (ΔL) by the positioning element (46).

30. The printing unit (01) according to claim 28, characterized in that the spur gear (42) of each distribution cylinder (09) is in permanent engagement with the central gear wheel (41), regardless of the displacement of the central gear wheel (41) in the two operating positions thereof.

31. The printing unit (01) according to claim 26, characterized in that gear wheel (39), which is mounted on the rotational axis (33) of the forme cylinder (04) and can be engaged with the central gear wheel (41), is mounted so as to be at least freely rotatable on the rotational axis (33) of the forme cylinder (04).

32. The printing unit (01) according to claim 26, characterized in that the rotational axis (47) of the central gear wheel (41) and the rotational axis (33) of the forme cylinder (04) are arranged parallel to and spaced from one another.

33. The printing unit (01) according to claim 26, characterized in that gear wheel (39), which is mounted on the rotational axis (33) of the forme cylinder (04) and can be brought into toothed engagement with the central gear wheel (41), has an edge width (B1) which is less than one-half the respective edge width (B2) of the spur gears (42) of the distribution cylinders (09).

34. The printing unit (01) according to claim 26, characterized in that a faster or slower speed of the distribution cylinders (09) is adjusted by mans of a gear ratio, which results from a ratio of the number of teeth on the respective spur gear (42) of the relevant distribution cylinder (09) to the number of teeth on the gear wheel (38), arranged non-rotatably in the same plane (E2) on the rotational axis (37) of the transfer cylinder (06).

35. The printing unit (01) according to claim 26, characterized in that the forme cylinder (04) is mounted so as to be axially displaceable along an adjustment path (ΔS).

36. The printing unit (01) according to claim 26, characterized in that the drive motor (29) is assigned to only a single printing couple (03).

37. The printing unit (01) according to claim 26, characterized in that in the printing couple (03), only the forme cylinder (04) and the transfer cylinder (06) that interacts with this forme cylinder (04) and the distribution cylinders (09) of the inking unit (08) are driven in the drive train originating from the drive motor (29).

38. The printing unit (01) according to claim 26, characterized in that at least every ink transfer roller (12; 17) and ink forme roller (18) disposed in the inking unit (08) is driven via friction.

39. The printing unit (01) according to claim 26, characterized in that the distribution cylinders (09) are each embodied as oscillating in print operation.

40. The printing unit (01) according to claim 39, characterized in that the distribution cylinders (09) oscillate in a movement opposite one another.

41. The printing unit (01) according to claim 26, characterized in that two printing couples (03) are disposed in the same frame (02), wherein each of these printing couples (03) has one forme cylinder (04) and one transfer cylinder (06) that interacts with said forme cylinder (04), wherein the transfer cylinders (06) of these printing couples (03) are engaged against one another at least during print operation of this printing unit (01).

42. The printing unit (01) according to claim 41, characterized in that each of the printing couples (03) has a drive train with its own drive motor (29), which is separate in terms of drive from the other printing couple (03).

43. The printing unit (01) according to claim 27, characterized in that the positioning element (46) is embodied as a pneumatic positioning element (46).

44. The printing unit (01) according to claim 27, characterized in that the positioning element (46) is controlled or at least can be controlled from a control panel belonging to the printing unit (01).

45. The printing unit (01) according to claim 26, characterized in that the transmission (44) occupies an installation space having an overall height (H2) of less than 60% of the overall height (H1) of the printing couple (03).

46. The printing unit according to claim 26, characterized in that the drive train originating from the drive motor (29) and guided over the plurality of gear wheels (32; 34; 36; 38; 39; 41) of the transmission (44) ends at the spur gears (42) of these distribution cylinders (09).
